(19) United States
(12) Patent Application Publication
(10) Pub. No.: US 2014/0187095 A1
(43) Pub. Date: Jul. 3, 2014

(54) Female Socket for Power Cord

(71) Applicant: Wen-Chung Liu, Tao Yuan Xien (TW)

(72) Inventor: Wen-Chung Liu, Tao Yuan Xien (TW)

(21) Appl. No.: 13/730,720

(22) Filed: Dec. 28, 2012

(51) Int. Cl. H01R 13/502

(52) U.S. Cl. CPC H01R 13/502
USPC 439/638

(57) ABSTRACT

A female socket for power cord, including a plug terminal and an integrally formed jack body, the jack body comprises of an interconnecting piece of terminal hole, the matrix extended from the interconnecting piece and a side cover connected to the lateral margin of the matrix and buckled with the matrix. There is a scab on the matrix, there is a trip on said scab, there is a blocking part matching the trip on the inner wall of the side cover, there is a tenon on the side cover, and there is a tenon hole matching the tenon on the lateral margin of the matrix.

### BACKGROUND OF INVENTION

1. Field of the Invention

The present invention relates generally to a connector, and more particularly to a female socket for power cord.

2. Description of Related Art

At present, the power cord for computer connects a female socket to a male plug, as shown in FIG. 1, the female socket is usually composed of jack body 1 and side cover 2. As two dies must be prepared for producing jack body 1 and side cover 2, the cost is high and the production consumes much labor and time, it has no marketability. In addition, the defect rate of the finished products worked by two different molds is high and the assembly is difficult, the jack body 1 and the side cover 2 are combined by pressing the salient points in the concave holes, the closure is poor. The untight combination of male plug and female socket in practice may cause potential safety hazard of poor contact or creepage.

Thus, to overcome said problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The embodiment of this invention aims to solve technical matters by providing a female socket for power cord, the jack body is integrally formed, its production and machining are convenient, and it has low production cost and high quality.

In addition, the embodiment of this invention aims to provide a female socket for power cord, and matched trip and blocking part are set in the socket to enhance the closure.

In order to solve the aforesaid technical problems, a female socket for power cord is provided, including the plug terminal and the integrally formed jack body for containing said plug terminal, said jack body comprises of an interconnecting piece of terminal hole, a matrix extended from said interconnecting piece and a side cover connected to the lateral margin of said matrix and buckled with said matrix. There is a scab on said matrix, there is a trip on said scab, there is a blocking part matching said trip on the inner wall of said side cover, there is a tenon on said side cover, and there is a tenon hole matching said tenon on the lateral margin of said matrix.

Furthermore, there is a continuous groove in said scab connecting said terminal hole.

Furthermore, there are plug holes in said matrix and side cover.

Furthermore, there are annular ribs and grooves on the external surface of said side cover and the external surface of said matrix.

The aforesaid technical proposal has at least the following beneficial effects: the female socket for power cord of this invention has an integrally formed jack body, the jack body has simple structure, it is produced and machined conveniently, and it has low production cost and high quality; besides matched tenon and tenon hole, there are trip and blocking part on the matrix and side cover of female socket, the interaction between the trip and the blocking part further realizes the tight coupling between side cover and matrix, and enhances the closure between side cover and matrix. The female socket for power cord of this invention can be extensively used in the power cord products for electronic products including notebook computers.

### BRIEF DESCRIPTION OF THE DRAWINGS

FIG. 1 is the structural representation of female socket of the existing technology.

FIG. 2 is the developed schematic diagram of female socket of this utility model embodiment.

FIG. 3 is the developed schematic diagram at another angle of female socket of this utility model embodiment.

FIG. 4 is the structural representation of female socket of this utility model embodiment.

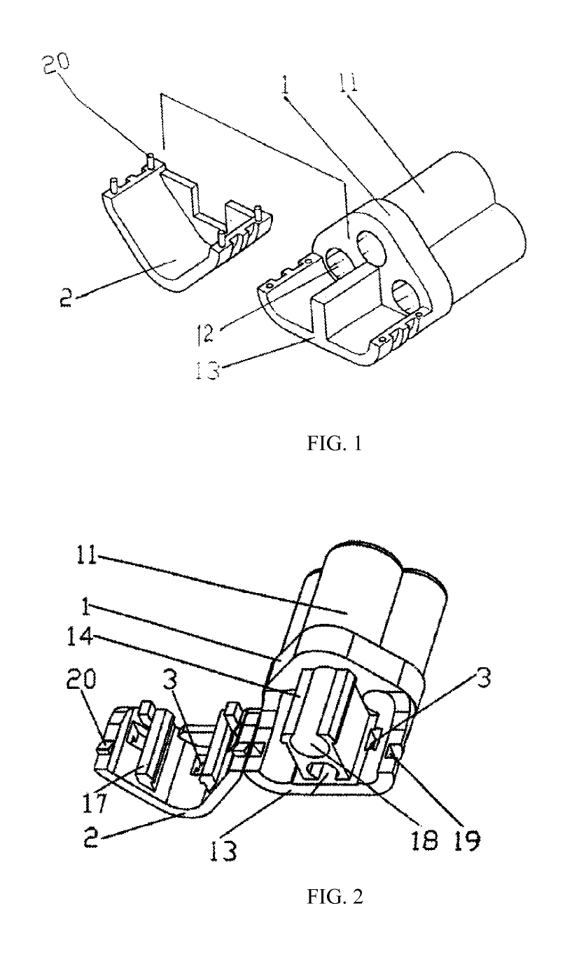

### DETAILED DESCRIPTION OF THE INVENTION

As shown in FIG. 2-FIG. 4, the female socket of this invention comprises of a plug terminal and an integrally formed jack body 1 for containing said plug terminal. Where the jack body 1 comprises of interconnecting piece 11, matrix 13 and side cover 2.

Said interconnecting piece 11 is formed of three circular cylinders overlapped in triangle, and each circular cylinder is drilled a terminal hole 12, said terminal hole 12 is a circular through hole for the conducting component of male plug to insert in; the matrix 13 is extended from one end of interconnecting piece 11, the lateral margin of matrix 13 is connected to the side cover 2. There is a tenon 20 on the edge of said side cover 2, and there is a tenon hole 19 matching the tenon 20 in the upper concave of lateral margin of matrix 13, the side cover 2 can be fixed to the matrix 13 by buckling the tenon 20 and the tenon hole 19.

Furthermore, there is a scab on said matrix 13, there is a trip 14 on both sides of the scab, and there is a blocking part 17 matching the trip 14 on the inner wall of said side cover 2. The tight coupling between side cover 2 and matrix 13 can be further realized by buckling the trip 14 and blocking part 17, so as to enhance the closure between side cover 2 and matrix 13.

As shown in FIG. 2, there is a continuous groove 18 connecting the terminal hole 12 in the scab, and there is a plug hole 3 in the matrix 13 and in the side cover 2.

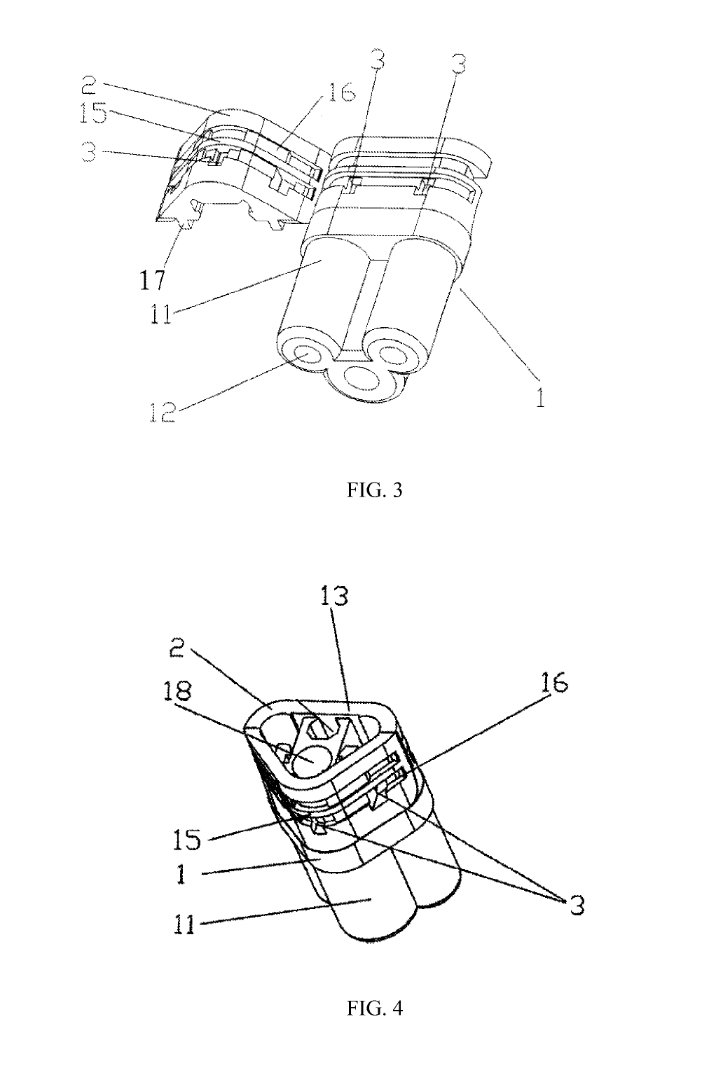

As shown in FIG. 3, there are annular rib 15 and groove 16 on the external surface of side cover 2 and the external surface of matrix 13.

The trip 14 on the matrix 13 of jack body 1 and the blocking part 17 on the inner wall of side cover 2 are buckled up, and the tenon 20 on the edge of side cover 2 is plugged into the tenon hole 19 in the upper concave of lateral margin of matrix 13, so that the side cover 2 and matrix 13 are coupled tightly. For casing the socket, the rib 15 and groove 16 circling the external surface of side cover 2 and the external surface of matrix 13 can couple the jack body 1 with the outer casing tightly, preventing the jack body 1 from shifting effectively. In practice, the airtightness, safety and service life of the female socket can be improved by filling the plug hole 3 with plastic material, and the potential safety hazard of poor contact between male plug and female socket or creepage can be prevented.

Although the invention has been explained in relation to its preferred embodiment, it is to be understood that many other possible modifications and variations can be made without departing from the spirit and scope of the invention as hereinafter claimed.

1. A female socket for power cord, it is characterized by a plug terminal and an integrally formed jack body for containing said plug terminal, said jack body comprises of an interconnecting piece of terminal hole, a matrix extended from said interconnecting piece and a side cover connected to the lateral margin of said matrix and buckled with said matrix; there is a scab on said matrix, there is a trip on said scab, there is a blocking part matching said trip on the inner wall of said side cover, there is a tenon on said side cover, and there is a tenon hole matching said tenon on the lateral margin of said matrix.

2. The female socket for power cord as claimed in claim 1, wherein that there is a continuous groove connecting said terminal hole in said scab.

3. The female socket for power cord as claimed in claim 1, wherein there is a plug hole in said matrix and side cover.

4. The female socket for power cord as claimed in claim 1, wherein there are annular rib and groove on the external surface of said side cover and the external surface of said matrix.
